(19) United States
(12) Patent Application Publication
(10) Pub. No.: US 2009/0188849 A1
(43) Pub. Date: Jul. 30, 2009

(54) COOLANT RECYCLING SYSTEM

(75) Inventors: Jung-Chih Hsu, Taoyuan County (TW); Chun-Wei Wu, Taoyuan County (TW)

Correspondence Address: QUINTERO LAW OFFICE, PC, 2210 MAIN STREET, SUITE 200, SANTA MONICA, CA, 90405, US

(73) Assignee: INOTERA MEMORIES, INC., TAOYUAN (TW)

(21) Appl. No.: 12/061,855

(22) Filed: Apr. 3, 2008

(30) Foreign Application Priority Data
Jan. 29, 2008 (TW) TW97103229

(51) Int. Cl. B01D 21/30; B01D 29/88; F25B 45/00

(52) U.S. Cl. 210/149; 210/196; 62/292

(57) ABSTRACT

A coolant recycling system is disclosed, including a chiller and a coolant filtering unit. The chiller includes a coolant tank, a compressor, a condenser and an expansion valve. The coolant tank includes an evaporator, a coolant outlet and an coolant inlet. The evaporator, the compressor, the condenser and the expansion valve are connected in sequence to form a refrigerant loop. The coolant filtering unit includes an unfiltered storage container, a dehydration filter and a filtered storage container. The unfiltered storage container is connected to the coolant outlet and the filtered storage container is connected to the coolant inlet.

### BACKGROUND OF THE INVENTION

1. Field of the Invention

The invention relates to a coolant recycling system, and more particularly to a coolant recycling system with a coolant filtering unit.

2. Description of the Related Art

Referring to FIG. 1, FIG. 1 is a schematic view of a conventional coolant recycling system. The conventional coolant system 10 comprises a chiller 11. The chiller 11 comprises a coolant tank 111, a compressor 112, a condenser 113, an expansion valve 114, a pump 117 and a filter device 118. The coolant tank 111 comprises an evaporator 115 and a temperature controller 116. The evaporator 115, the compressor 112, the condenser 113 and the expansion valve 114 are connected in sequence to form a refrigerant loop. The temperature controller 116, the pump 117 and the filter device 118 are connected in sequence to form a coolant loop. The cooling water is delivered to inner pads 12 and 13 and a shell 14 of a machine tool 15 via the pump 117. After using the coolant system 10, the machine tool 15 is dismantled for cleaning. However, because the inner pads 12 and 13 and the shell 14 of the machine tool 15 comprise a plurality of pipelines, water and particles can easily remain therein after cleaning. If the inner pads 12 and 13 and the shell 14 of the machine tool 15 with water and particles are assembled with the chiller 11, water and particles may enter the coolant tank 111. When the coolant system 10 operates, the temperature of the coolant tank 111 is approximately minus 20° C., thus, freezing water. If ice and particle are delivered to the coolant tank 111, operation of the evaporator 115 will be hampered. In a worst case scenario, the temperature of the coolant tank 111 will increase to cause the coolant system 10 to break down.

### BRIEF SUMMARY OF THE INVENTION

The invention provides a coolant recycling system. The coolant recycling system comprises a chiller and a coolant filtering unit. The chiller comprises a coolant tank, a compressor, a condenser and an expansion valve. The coolant tank comprises an evaporator, an coolant outlet and an coolant inlet. The evaporator, the compressor, the condenser and the expansion valve are connected in sequence to form a refrigerant loop. The coolant filtering unit comprises an unfiltered storage container, a dehydration filter and a filtered storage container. The unfiltered storage container, the dehydration filter and the filtered storage container are connected in sequence. The coolant filtering unit is connected to the chiller. The unfiltered storage container is connected to the coolant outlet of the coolant tank. The filtered storage container is connected to the coolant inlet of the coolant tank.

In one embodiment, the chiller further comprises a pump and a filter device, and the coolant tank, the pump and the filter device are connected in sequence.

In another embodiment, the coolant filtering unit further comprises a water collector connected to the dehydration.

In still another embodiment, the coolant filtering unit further comprises a drainage coolant outlet connected to the water collector.

In still another embodiment, the coolant filtering unit further comprises an exist higher than the coolant inlet of the coolant tank.

In still another embodiment, the coolant filtering unit further comprises a pump respectively connected to the filtered storage container and the coolant inlet of the coolant tank.

In still another embodiment, the coolant tank comprises a temperature controller to control the temperature of the coolant tank.

In still another embodiment, the coolant recycling system further comprises a machine tool, wherein the machine tool comprises an inner pad and a shell with a plurality of pipelines.

### BRIEF DESCRIPTION OF DRAWINGS

FIG. 1 is a schematic view of a conventional coolant recycling system;

FIG. 2 is a schematic view of an embodiment of a coolant recycling system of the invention; and

FIG. 3 is a schematic view of another embodiment of a coolant recycling system of the invention.

The invention can be more fully understood by reading the subsequent detailed description and examples with references made to the accompanying drawings.

### DETAILED DESCRIPTION OF THE INVENTION

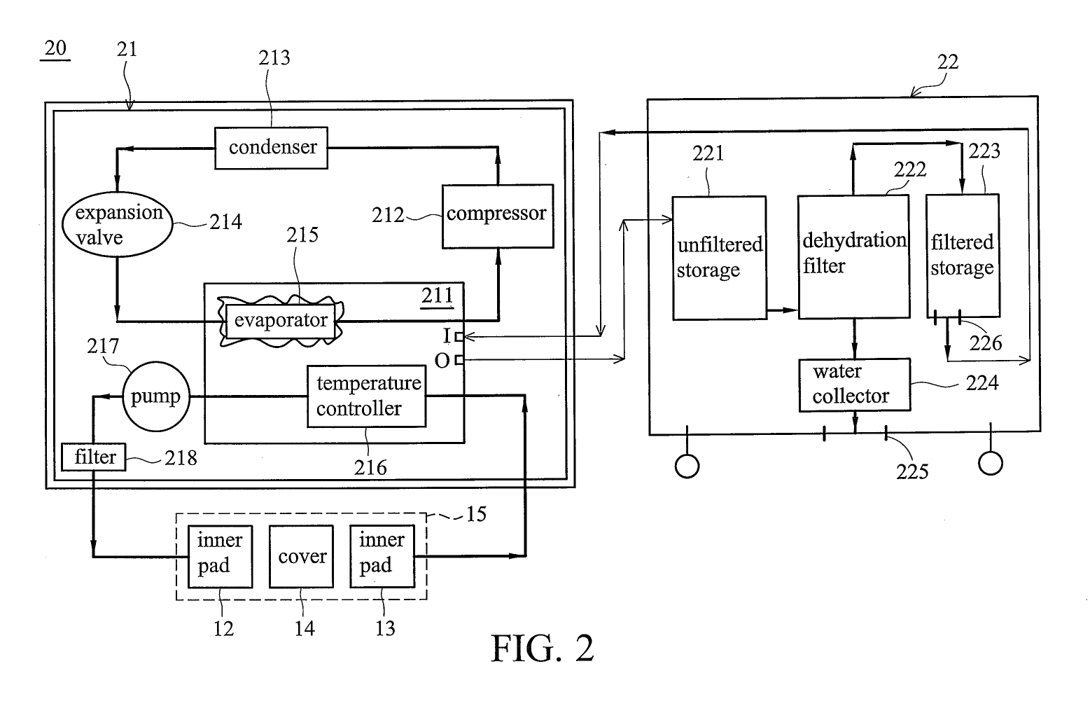

Referring to FIG. 2, FIG. 2 is a schematic view of an embodiment of a coolant recycling system of the invention. The coolant recycling system 20 comprises a chiller 21 and a coolant filtering unit 22. The chiller 21 comprises a coolant tank 211, a compressor 212, a condenser 213, an expansion valve 214, a pump 217 and a filter device 218. The coolant tank 211 comprises an evaporator 215 and a temperature controller 216. The evaporator 215, the compressor 212, the condenser 213 and the expansion valve 214 are connected in sequence to form a refrigerant loop. The temperature controller 216, the pump 217, the filter device 218 and a machine tool 15 are connected in sequence to form a coolant loop. The coolant tank 211 of the chiller 21 further comprises a coolant outlet O and an coolant inlet I. In this embodiment, coolant recycling system 20 further includes a machine tool 15. The machine tool 15 includes two inner pads 12 and 13 and a shell 14 with a plurality of pipelines.

The coolant filtering unit 22 comprises an unfiltered storage container 221, a dehydration filter 222, a filtered storage container 223, a water collector 224 and a drainage coolant outlet 225. The unfiltered storage container 221, the dehydration filter 222 and the filtered storage container 223 are connected in sequence. The unfiltered storage container 221 is connected to the coolant outlet O. The dehydration filter 222 is connected to the water collector 224. The water collector 224 is connected to the drainage coolant outlet 225 for collecting filtered water and particles and then discharging via the drainage coolant outlet 225. The filtered storage container 223 is connected to the coolant inlet I.

Note that the coolant tank 211 of the chiller 21 is full of coolant. When the coolant is discharged via the coolant outlet O, the coolant enters the unfiltered storage container 221. Water and particles in the coolant is filtered via the dehydration filter. The filtered coolant is collected in the filtered storage container 223. Water and particles are collected in the water collector 224 and discharged via the drainage coolant outlet 225. The filtered storage container 223 comprises an exist 226. The filtered coolant passes through the exist 226 and the coolant inlet I to flow back into the coolant tank 211 for ensuring filtered coolant without any water and particles. In this embodiment, the exist 226 is higher than the coolant inlet I of the coolant tank 221. The pressurized difference between the coolant inlet I and the exist 226 allows the coolant to flow back from the filtered storage container 223 to the coolant tank 221.

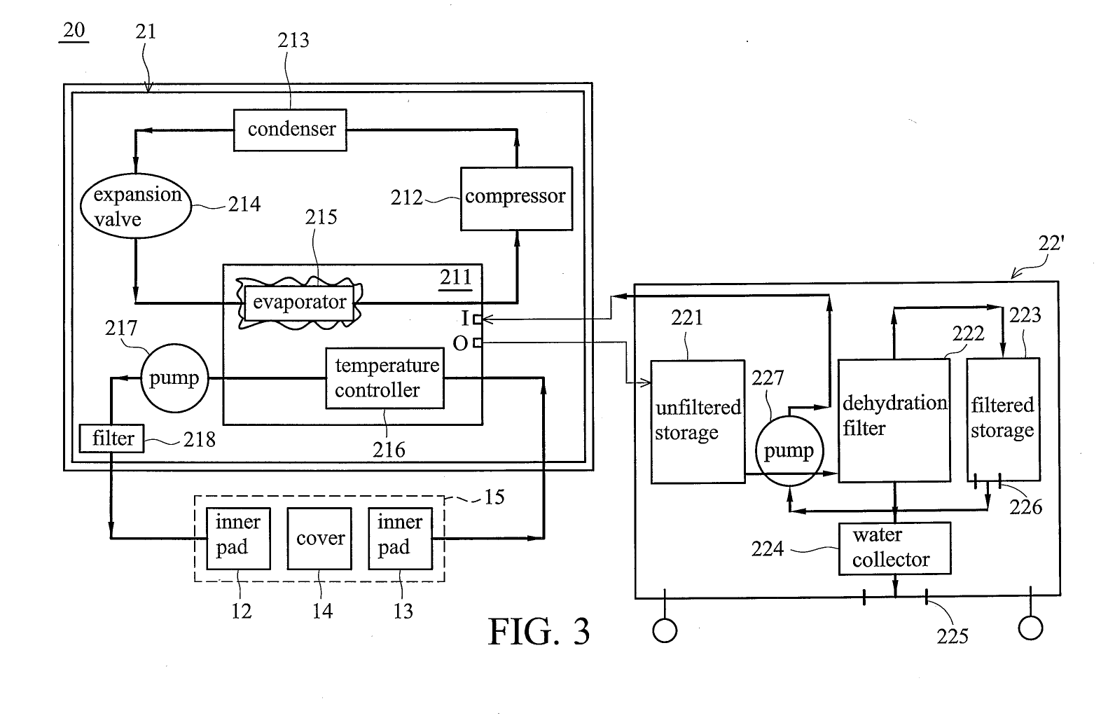

Referring to FIG. 3, FIG. 3 is a schematic view of another embodiment of a coolant recycling system of the invention. This embodiment is approximately similar to the embodiment of FIG. 2, thus, similar descriptions are omitted for brevity. The main differences between the embodiments of FIG. 3 and FIG. 2 are that the exist 226 of the filtered storage container 223 of the coolant filtering unit 22′ for FIG. 3 is not higher than the coolant inlet I, and the coolant filtering unit 22′ further comprises a pump 227. The pump 227 allows the coolant to flow from the storage 223 to the coolant inlet I.

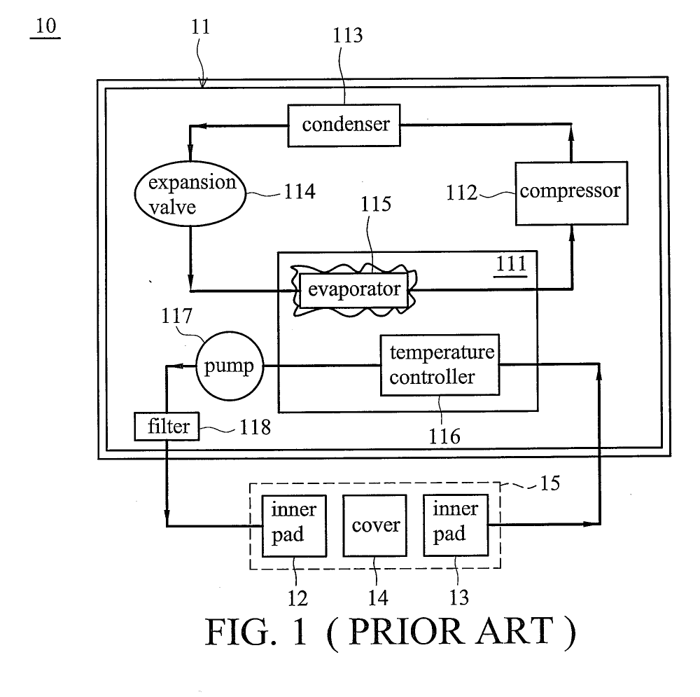

The invention provides a coolant recycling system with a coolant filtering unit to avoid water and particles from entering the coolant recycling system after the coolant recycling system is cleaned like in the conventional art. Whereby, water and particles hamper the operation of the evaporator 115 and in a worst case scenario, the temperature of the coolant tank 111 increases, resulting in the coolant system 10 to break down (refer to FIG. 1).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A coolant recycling system, comprising:
a chiller comprising:
a coolant tank including an evaporator, an coolant outlet and an coolant inlet;
a compressor;
a condenser; and
an expansion valve; and
a coolant filtering unit comprising:
an unfiltered storage container;
a dehydration filter; and
a filtered storage container;
wherein the evaporator, the compressor, the condenser and the expansion valve are connected in sequence forming a refrigerant loop; and
wherein the unfiltered storage container, the dehydration filter and the filtered storage container are connected in sequence such that the coolant filtering unit is connected to the chiller, the unfiltered storage container is connected to the coolant outlet of the coolant tank, and the filtered storage container is connected to the coolant inlet of the coolant tank.

2. The coolant recycling system as claimed in claim 1, wherein the chiller further comprises a pump and a filter device, and wherein the coolant tank, the pump and the filter device are connected in sequence.

3. The coolant recycling system as claimed in claim 1, wherein the coolant filtering unit further comprises a water collector connected to the dehydration filter.

4. The coolant recycling system as claimed in claim 3, wherein the coolant filtering unit further comprises a drainage coolant outlet connected to the water collector.

5. The coolant recycling system as claimed in claim 1, wherein the coolant filtering unit further comprises an exist higher than the coolant inlet of the coolant tank.

6. The coolant recycling system claimed in claim 1, wherein the coolant filtering unit further comprises a pump respectively connected to the filtered storage container and the coolant inlet of the coolant tank.

7. The coolant recycling system claimed in claim 1, wherein the coolant tank comprises a temperature controller to control the temperature of the coolant tank.

8. The coolant recycling system claimed in claim 1, further comprising a machine tool, wherein the machine tool comprises an inner pad and a shell with a plurality of pipelines.
